(19) United States
(12) Patent Application Publication
(10) Pub. No.: US 2024/0304877 A1
(43) Pub. Date: Sep. 12, 2024

(54) METHOD AND SYSTEM FOR DISCHARGING SPENT LITHIUM ION BATTERIES

(71) Applicant: AGR LITHIUM INC., Houston, TX (US)

(72) Inventors: Vijay CHAUDHARI, Noida (IN); Amol NAIK, Noida (IN); Vipin TYAGI, Houston, TX (US); Nishchay CHADHA, Singapore (SG)

(73) Assignee: AGR LITHIUM INC., Houston, TX (US)

(21) Appl. No.: 18/595,930

(22) Filed: Mar. 5, 2024

Related U.S. Application Data
(60) Provisional application No. 63/450,560, filed on Mar. 7, 2023.

(51) Int. Cl. H01M 10/44; H01M 10/54

(52) U.S. Cl. CPC H01M 10/44; H01M 10/54

(57) ABSTRACT

A method of discharging a spent lithium-ion (Li-ion) battery may include contacting external electrodes of the spent Li-ion battery to a discharging solution. The discharging solution including an aqueous solution of salts having a same anion and a redox couple as cations. The redox couple includes a first cation of a metal having a first oxidation state and a second cation of the same metal having a second oxidation state different from the first oxidation state.

### CROSS-REFERENCE TO RELATED APPLICATIONS

This application claims the benefit of priority to U.S. Provisional Patent Application No. 63/450,560, filed on Mar. 7, 2023, which is incorporated herein by reference in its entirety for all purposes.

### FIELD

The present disclosure relates generally to the field of recycling of spent lithium ion batteries, and in particular to systems and methods for discharging spent lithium ion batteries.

### BACKGROUND

The number of spent lithium-based batteries is projected to grow rapidly as electric powered equipment, such as automobiles, power tools, etc., becomes commonplace. Given that the amount of metals and other natural resources that are used as raw materials for lithium-based batteries is finite, economically viable methods of recycling the spent batteries are necessary to keep the cost of the raw materials (and consequently, of the batteries), affordable.

Any discarded battery typically has some amount of residual voltage. Depending on the size of the battery and the residual voltage, suddenly discharging the battery during a recycling process can result in a large current, potentially creating substantial amount of heat or even a spark. Lithium-based batteries typically tend to have a higher residual voltage and higher residual charge because of their design and chemistry. Moreover, the lithium-based batteries include flammable materials which can combust as a result of the heat and/or the spark, thereby creating hazardous conditions during the recycling process when the discarded batteries are crushed and/or dismantled.

Consequently, lithium-based batteries are routinely pre-treated before recycling so as to reduce the residual voltage to acceptable levels. The pre-treatment typically includes chemically discharging the batteries using aqueous salt solution. Mostly, sodium chloride (NaCl) salt solution is believed to be efficient mode of cell discharge. However, corrosive nature of NaCl salt solution damages the cells and leads to leakage and loss of valuable cell ingredients. Moreover, the by-products of such discharging process (e.g., chlorine gas) are toxic to the environment and human health.

As alternatives to NaCl, salts like ferrous sulphate, manganese sulphate, etc. have also been tested and reported with some positive achievements in discharge process. Nonetheless, these discharge solutions lack efficient kinetics of cell discharge and generally take several hours or sometimes more than day to perform the discharging process. Secondly, despite slower discharge kinetics final cell potential is relatively high and some safety issues remain.

Consequently, current technologies for discharging spent batteries are not safe and time-efficient. Cost-effective, low energy, sustainable, safe and fast techniques for discharging spent batteries are, therefore, needed.

### SUMMARY

The embodiments disclosed herein stem from the realization that when an aqueous solution having suitably selected salts, of a same metal with differing oxidation states having reversible redox process with suitable potential, is used as a discharging solution, evolution of toxic gases can be avoided without reducing the rate of discharge. The present application discloses systems and methods for discharging spent batteries, e.g., spent Li-ion batteries, using an aqueous solution of salts comprising a redox couple and a same anion. As a battery is discharged through the aqueous solution, at both electrodes metal ions from solution reversibly undergo reduction and oxidation reaction. By suitably selecting the cation redox couple along with counter anion, evolution of toxic gases can be avoided.

The discharging solution of the presently disclosed embodiments is selected such that the metal cations can undergo redox processes, reversibly at the battery external electrodes and hence, maintain their effective solution concentration without modifying the battery external electrode. Secondly, the anion of the discharging salt solution also possess appreciable redox activity with efficient kinetics, so that redox kinetics at both external electrodes are similar. Thus, corrosion of the external electrodes of the battery may also be avoided. Further, by selecting a redox couple with a suitable reduction potential, with respect to the battery individual electrode potentials, the battery may be discharged to a sufficiently low voltage. Thus, the potential for spark discharge when dismantling the battery is further reduced.

Advantageously, the embodiments disclosed herein enable discharging of a spent Li-ion battery to a safe potential without evolving hazardous or toxic gases with efficient kinetics. Further, as will be apparent, the systems and methods disclosed herein avoid potential corrosion of components of battery during the discharging process, thereby improving the yield of recycling when the battery components are recycled.

Accordingly, in at least one embodiment, a method of discharging a spent Li-ion battery may include contacting external electrodes of the spent Li-ion battery to a discharging solution. The discharging solution is an aqueous solution including salts having a same anion and a redox couple as cations. The redox couple includes a first cation of a metal having a first oxidation state and a second cation of the same metal having a second oxidation state different from the first oxidation state.

In accordance with at least one embodiment, a system for discharging a spent Li-ion battery may include a container having a discharging solution therein. The discharging solution includes an aqueous solution of salts having a same anion and a redox couple as cations. The redox couple comprises a first cation of a metal having a first oxidation state and a second cation of the same metal having a second oxidation state different from the first oxidation state. The system further includes a voltage sensor configured to measure a voltage across external electrodes of the spent Li-ion battery, and a controller operably connected to the voltage sensor. The controller is configured to initiate a contact between external electrodes of the spent Li-ion battery and the discharging solution, and disengage the contact between the external electrodes and the discharging solution when the voltage measured by the voltage sensor across the external electrodes of the spent Li-ion battery being below a threshold voltage.

Additional features and advantages of the subject technology will be set forth in the description below, and in part will be apparent from the description, or may be learned by practice of the subject technology. The advantages of the subject technology will be realized and attained by the structure particularly pointed out in the written description and embodiments hereof as well as the appended drawings.

It is to be understood that both the foregoing general description and the following detailed description are exemplary and explanatory and are intended to provide further explanation of the subject technology.

### BRIEF DESCRIPTION OF THE DRAWINGS

Various features of illustrative embodiments of the present disclosure are described below with reference to the drawings. The illustrated embodiments are intended to illustrate, but not to limit, the present disclosure. The drawings contain the following figures:

FIG. 1A schematically shows discharging of a spent battery in accordance with at least some embodiments of the present disclosure.

FIG. 1B schematically shows discharging of a spent battery in accordance with at least some embodiments of the present disclosure.

FIG. 2 shows a system for discharging a spent battery in accordance with at least some embodiments of the present disclosure.

### DETAILED DESCRIPTION

In the following detailed description, numerous specific details are set forth to provide a full understanding of the subject technology. It should be understood that the subject technology may be practiced without some of these specific details. In other instances, well-known structures and techniques have not been shown in detail so as not to obscure the subject technology.

Further, while the present description sets forth specific details of various embodiments, it will be appreciated that the description is illustrative only and should not be construed in any way as limiting. Additionally, it is contemplated that although particular embodiments of the present disclosure may be disclosed or shown in the context of recycling of lithium ion batteries, such embodiments can be used with all types of batteries using modifications within the scope of the present disclosure and claims. Furthermore, various applications of such embodiments and modifications thereto, which may occur to those who are skilled in the art, are also encompassed by the general concepts described herein.

A lithium-ion (Li-ion) battery cell has a voltage ranging between about 3.6 V and about 4.2 V depending on the specific chemistry of the battery. For most applications, once the voltage of the cell drops below 3.4 V, the battery cell is generally considered to be “dead,” and most manufacturers build circuit cut-offs to prevent the voltage from dropping below about 3.0 V. Thus, even at the end of life, a discarded spent Li-ion battery may have a voltage in a range from about 2.5 V to about 3.0 V. In other words, a discarded spent Li-ion battery may hold substantial amount of charge depending on the battery chemistry, size and conditions immediately prior to the battery being discarded.

During the process of recycling a Li-ion battery, the initial step is generally to crush or dismantle the battery using, for example, a metallic crusher. However, if the battery holds substantial amount of charge, battery may spontaneously discharge during the crushing process potentially causing a spark or substantial amount of heating of the crusher parts.

In order to reduce such a risk, battery cells are discharged before crushing them for subsequent recycling processes. The most obvious method for discharging battery cells is by shorting external electrodes. However, when a large amount of battery cells need to be discharged, the resulting high currents can generate high heat that can potentially ignite the materials inside the battery cells. The high currents and high heat can also damage and corrode the materials of the battery, reducing the recycling yield.

An alternative method for discharging batteries is by connecting the external electrodes to a conducting solution and allowing the batteries to discharge through the conducting solution. Most commonly used conducting solution is an aqueous solution of common salt or sodium chloride (NaCl), which has high solubility and can sustain high current densities resulting in effective battery discharge.

However, in NaCl based discharge solution the high current density results in water electrolysis through reduction into hydrogen gas production at the negative electrode and oxygen evolution at the positive electrode. Presence of chloride ions at positive terminal competes with oxygen evolution and its kinetics is faster than oxygen evolution. This process triggers metal dissolution at negative terminal which damages the cell and also generates solid content into the discharge solution (e.g., iron or copper hydroxide and oxides depending on the chemistry of the battery and its external electrodes). Furthermore, deposition on cell terminal creates barrier that impedes further cell discharge. Consequently, the battery is left with significant residual potential which do not alleviate the safety issues for cell crushing completely. Further, the evolved hydrogen is highly flammable, and thus, can have other associated safety issues.

The present inventors have realized that the kinetic burden caused by NaCl, and particularly by the presence of chloride ions, can be avoided by the presence of suitable electroactive species with faster kinetics. Consequently, metal dissolution at negative terminal can be avoided, thereby helping achieve the faster, safer and cleaner cell discharge.

According to an aspect of the present disclosure, a method of discharging a spent Li-ion battery includes contacting external electrodes of the spent Li-ion battery to a discharging solution. The discharging solution includes an aqueous solution of salts having a same anion and a redox couple as cations. The redox couple includes a first cation of a metal having a first oxidation state and a second cation of the same metal having a second oxidation state different from the first oxidation state.

As used to herein, the term “redox couple” refers a pair of cations of a same metal with different oxidations states. In other words, a redox couple refers to cations of a same metal but having different positive charge. The cations of a redox couple can convert from one to another via an oxidation or a reduction reaction upon application of suitable potential. Examples of redox couples include, but are not limited to, Fe²⁺/Fe³⁺, Fe²⁺/Fe, Fe³⁺/Fe, Cu⁺/Cu²⁺, Cu⁺/Cu, Cu²⁺/Cu, Mn²⁺/Mn³⁺, Mn²⁺/Mn⁴⁺, Mn²⁺/Mn⁷⁺, Mn²⁺/Mn⁵⁺, Mn²⁺/Mn, V²⁺/V, V²⁺/V³⁺, V²⁺/V⁺, V²⁺/V⁵⁺, Sn²⁺/Sn⁺, Cr³⁺/Cr⁶⁺, Cr²⁺/Cr³⁺, Co²⁺/Co³⁺, Ni²⁺/Ni³⁺, Sn²⁺/Sn⁴⁺, and Pb²⁺/Pb⁴⁺.

One factor in selecting a suitable redox couple for use in the discharging solution is the reduction potential of the redox couple, which determines the minimum voltage to which the Li-ion battery may be discharged when contacted with the discharging solution.

Those of ordinary skill in the art would appreciate that it is desirable to have cations with higher reduction potential compared to the battery negative electrode and lower reduction potential compared battery positive electrode along with reversible nature of redox processes. Thus, while the battery discharges, one of the cation can reduce at the battery negative electrode and other or in situ generated cation can oxidize at the battery positive electrode.

In some embodiments, the anions of the salt in the discharging solution can be selected from the group consisting of sulfate, phosphate, nitrate, oxide, chloride, acetate, oxalate, carbonate and hydroxide. However, those of ordinary skill in the art would appreciate that one of the factors in selecting the anion is the kinetics of the anion at the external electrode. As has been discussed herein, if the kinetics of the anion at the terminal is slower than water electrolysis, dissolution of the metal at the terminal occurs, thereby corroding the battery terminal, and potentially resulting in evolution of toxic gases. Thus, a preferred anion is one with faster redox kinetics at the battery terminal. Same is applied for cation redox kinetics, i.e., processes occurring at the battery negative terminal. Consequently, in some embodiments, the preferred anion is selected from the group consisting of sulfate, nitrate, phosphate, acetate, oxalate, carbonate, oxide and hydroxide.

Further implication of faster redox kinetics of cations/anions is that it can avoid drastic alteration in pH of discharge solution by competing with water electrolysis. Thus, another factor to be considered is the electrochemical stability of the cations in an aqueous solution, in particular in an aqueous solution at acidic pH.

Those of ordinary skill in the art would further appreciate that in order to obtain a discharging solution, the salts of the selected anion and both the cations of the redox couple must be soluble in water. This requirement further reduces the choice of anions available for the discharging solution. Thus, in some embodiments, the anion is selected from the group consisting of sulfate, nitrate, acetate, carbonate, and oxalate, although other anions are contemplated within the scope of the present disclosure.

For example, in some embodiments, the discharging solution may include sulfates, acetates or oxalates of Fe²⁺ and Fe³⁺ or of Cu²⁺ and Cut. In some embodiments, the discharging solution may include sulfates of Fe²⁺ and Fe³⁺.

In some embodiments, the concentration of one or both the salts in the discharging solution (prior to being contacted with the spent battery) may be in a range from about 0.01 M to about 5 M. For example, in some embodiments, the salt with high oxidation number cation may have a concentration in the range from about 0.01 M to about 0.5 M and the salt with the low oxidation number cation may have a concentration in the range from 0.05 M to about 1 M.

In some embodiments, the salt with high oxidation number cation may have a concentration in the range from about 0.05 M to about 0.5 M. In some embodiments, the salt with the high oxidation number cation may have a concentration in the range from about 0.1 M to about 0.5 M. In some embodiments, the salt with the high oxidation number cation may have a concentration in the range from about 0.15 M to about 0.5 M. In some embodiments, the salt with the high oxidation number cation may have a concentration in the range from about 0.2 M to about 0.5 M. In some embodiments, the salt with the high oxidation number cation may have a concentration in the range from about 0.25 M to about 0.5 M. In some embodiments, the salt with the high oxidation number cation may have a concentration in the range from about 0.3 M to about 0.5 M. In some embodiments, the salt with the high oxidation number cation may have a concentration in the range from about 0.4 M to about 0.5 M. In some embodiments, the salt with the high oxidation number cation may have a concentration in the range from about 0.2 M to about 0.5 M. In some embodiments, the salt with the high oxidation number cation may have a concentration in the range from about 0.2 M to about 0.45 M. In some embodiments, the salt with the high oxidation number cation may have a concentration in the range from about 0.2 M to about 0.4 M. In some embodiments, the salt with the high oxidation number cation may have a concentration in the range from about 0.2 M to about 0.3 M.

In some embodiments, the salt with low oxidation number cation may have a concentration in the range from about 0.01 M to about 0.5 M. In some embodiments, the salt with low oxidation number cation may have a concentration in the range from about 0.01 M to about 0.3 M. In some embodiments, the salt with low oxidation number cation may have a concentration in the range from about 0.1 M to about 0.4 M. In some embodiments, the salt with low oxidation number cation may have a concentration in the range from about 0.1 M to about 0.15 M. In some embodiments, the salt with low oxidation number cation may have a concentration in the range from about 0.1 M to about 0.3 M.

Those of ordinary skill in the art would appreciate that the various concentration ranges described herein are limited by the solubility of corresponding salts in corresponding solutions and conditions.

Naturally, the maximum concentration of the salts is dependent on the solubility of the respective salt. Thus, in some embodiments, one or both the salts may be present in the discharging solution at saturation concentration. Likewise, in some embodiments, one or both the salts may be present in the discharging solution at relatively low concentration.

For example, in some embodiments, the salt with the low oxidation number cation is present at saturation concentration while the salt with the high oxidation number is present at very low concentrations such that when a spent battery is contacted with the discharging solution, the spent battery oxidizes the low oxidation number cation to the high oxidation number cation, thereby increasing the concentration of the high oxidation number cation. The high concentration of the low oxidation number cation, in such instances, may be useful in preventing or delaying discharge kinetics.

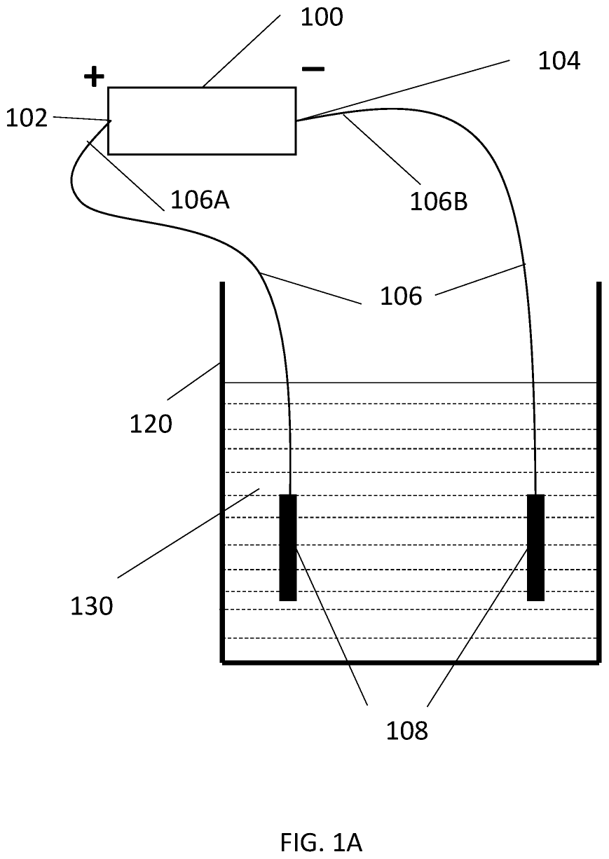

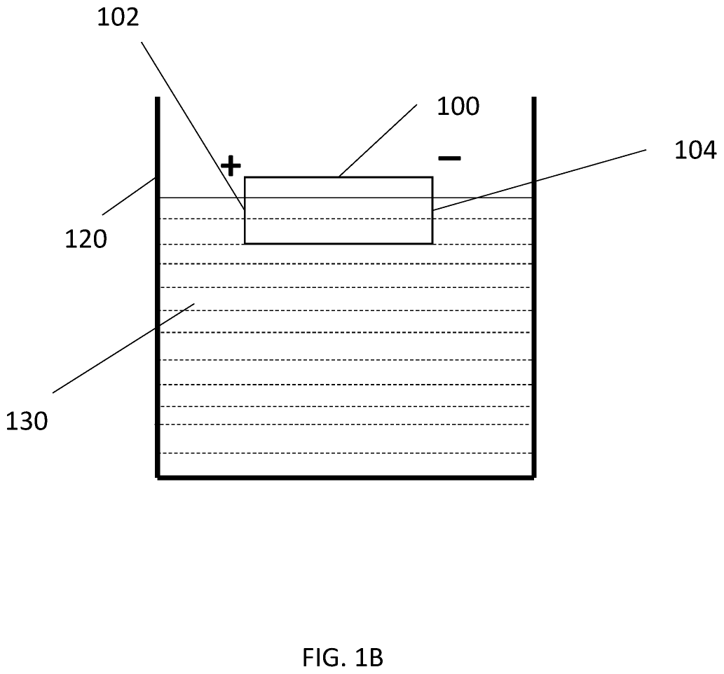

FIGS. 1A and 1B schematically show different types of contact between the external electrodes of the spent Li-ion battery and the discharging solution in accordance with some embodiments of the present disclosure.

For example, as depicted in FIG. 1A, in some embodiments, contacting the external electrodes 102 and 104 of the spent Li-ion battery 100 to the discharging solution 130 involves contacting the external electrodes 102 and 104 to first ends 106A/106B of electrical conductors 106 and contacting second ends 108 of the electrical conductor 106 to the discharging solution 130 contained in the container 120. In some embodiments, a switch (not shown) may be included on one of the conductors 106 to control the contact between the external electrode 102/104 and the discharging solution 130. In such instances, the switch may be turned ON or OFF to enable or disable discharging of the battery. For example, the switch may be turned OFF when the voltage between the external electrodes reduced below a certain threshold voltage.

FIG. 1B depicts an alternate type of contact between the external electrodes of the spent Li-ion battery and the discharging solution. In the example depicted in FIG. 1B, the spent Li-ion battery 100 is immersed in the container 120 containing the discharging solution 130 such that the external electrodes 102/104 of the battery 100 are in direct contact with discharging solution 130. In such embodiments, the battery 100 may be removed from the discharging solution 130 once the discharging process is complete, e.g., when the voltage between the external electrodes is reduced below a certain threshold voltage. The immersion or removal of the battery 100 may be performed, e.g., by a robotic arm (not shown).

In some embodiments, the threshold voltage is in a range from about 10 mV to about 1.5 V. Those of ordinary skill in the art would appreciate that while the threshold voltage may be selected to have a certain value, the final potential of a discharged battery is determined by the reduction potential of the redox couple. For example, reduction potential for conversion of Fe³⁺ to Fe²⁺ is about 0.77 V. The threshold potential may be selected to be higher than 0.77 V, e.g., about 0.80 V, about 0.85 V, about 0.90 V, about 0.95 V, about 1.0 V, about 1.05 V, about 1.10 V, about 1.15 V, about 1.20 V, about 1.25 V, about 1.30 V, about 1.35 V, about 1.40 V, about 1.45 V, about 1.50 V, or any other suitable potential between any two of these values. In some embodiments, the threshold potential may be in a suitable range surrounding any two of these values.

Without wishing to be bound by theory, it is possible to obtain a threshold potential lower than the reduction potential of the redox couple by suitably manipulating the various parameters associated with the discharging process such as, for example, by suitably agitating the discharging solution to replenish the cations or anions in the discharging solution, or supplementing the redox couple with one or more other ionic species. Thus, in some embodiments, the threshold potential may be, for example, about 50 mV, about 100 mV, about 150 mV, about 200 mV, about 250 mV, about 300 mV, about 350 mV, about 400 mV, about 450 mV, about 500 mV, about 550 mV, about 600 mV, about 650 mV, about 700 mV, about 750 mV, about 800 mV, about 850 mV, about 900 mV, about 950 mV, about 1 V, or any value between any two of these values, or in a suitable range surrounding any two of these values.

In some embodiments, it may be more efficient to determine a threshold voltage that can be achieved at a high rate while maintaining safety during subsequent recycling processes. Thus, a suitable threshold potential may be selected based on, e.g., the risk of spark or high current during the process of dismantling the battery for subsequent recycling processes. Consequently, a suitable threshold voltage may be set based on the particular steps that will be performed when recycling the discharged battery.

Without wishing to be bound by theory, the process of discharging the battery and the resulting current flow through the discharging solution may increase the temperature of the discharging solution, which may affect the efficiency of discharging, reactions at the battery terminal(s) and/or the minimum voltage achievable upon discharging. Thus, it may be helpful, in some embodiments, to actively maintain the temperature of the discharging solution while the battery discharges through the discharging solution. Consequently, in some embodiments, the container containing the discharging solution may be cooled using a cooling mechanism, e.g., a water-based heat exchanger, so as to maintain the discharging solution at a particular temperature, e.g., at 25° C.

Without wishing to be bound by theory, the kinetic efficiency at the battery terminals may be increased by actively removing any material generated (e.g., evolved gas such as oxygen, and/or deposited materials such as salts of the material of the external electrode and/or other metals in the battery) at the battery terminals. Thus, in some embodiments, the discharging solution may be agitated so as to maintain a flow of the discharging solution around the battery terminal. In some embodiments, the agitation may be achieved using, e.g., a stirrer in the container containing the discharging solution to continuously stir the discharging solution. Any suitable stirrer such as, for example, a magnetic stirrer, may be used for stirring the discharging solution. In some embodiments, the agitation may be achieved using e.g., ultrasound vibrations applied to the walls of the container containing the discharging solution. Any suitable ultrasound generator such as, for example, a piezoelectric generator, may be used for applying ultrasound vibrations to the discharging solution. In some embodiments, the agitation may be achieved using, e.g., a rocker with a see-saw mechanism for rocking the container at a suitable oscillation frequency.

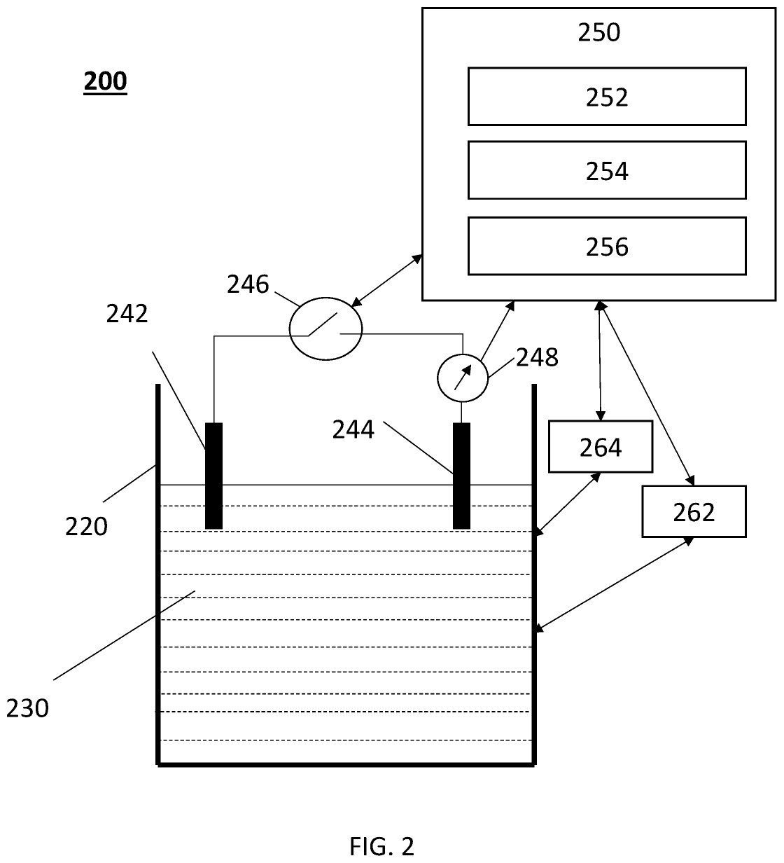

FIG. 2 schematically illustrates a system for discharging a spent Li-ion battery in accordance with some embodiments of the present disclosure.

In some embodiments, the system 200 includes a container 220 containing the discharging solution 230, a controller 250, and terminals 242 and 244.

The container 220 can be any suitable container that can contain the discharging solution being used without being corroded and without leaching components thereof into the discharging solution when current is applied to the discharging solution. In some embodiments, the container may be made of a ceramic material or glass. In some embodiments, the container may be made of a polymer material that is inert to the discharging solution at different pH and temperature conditions.

The discharging solution 230 may be an aqueous solution containing salts of a same anion and a redox couple as cations. The redox couple includes a first cation of a metal having a first oxidation state and a second cation of the same metal having a second oxidation state different from the first oxidation state. The cations of a redox couple can convert from one to another via an oxidation or a reduction reaction upon application of suitable potential. Examples of redox couples include, but are not limited to, Fe²⁺/Fc³⁺, Fc²⁺/Fe, Fc³⁺/Fc, Cut/Cu²⁺, Cut/Cu, Cu²⁺/Cu, Mn²⁺/Mn³⁺, Mn²⁺/Mn⁴⁺, Mn²⁺/Mn⁷⁺, Mn²⁺/Mn⁵⁺, Mn²⁺/Mn, V²⁺/V, V²⁺/V³⁺, V²⁺/V⁺, V²⁺/V⁵⁺, Sn²⁺/Sn⁺, Cr³⁺/Cr⁶⁺, Cr²⁺/Cr³⁺, Co²⁺/Co³⁺, Ni²⁺/Ni³⁺, Sn²⁺/Sn⁴⁺, and Pb²⁺/Pb⁴⁺.

In some embodiments, the anion is selected from the group consisting of sulfate, nitrate, acetate, carbonate, and oxalate, although other anions are contemplated within the scope of the present disclosure.

For example, in some embodiments, the discharging solution may include sulfates, acetates or oxalates of Fe²⁺ and Fe³⁺ or of Cu²⁺ and Cut. In some embodiments, the discharging solution may include sulfates of Fe²⁺ and Fe³⁺.

In some embodiments, the concentration of one or both the salts in the discharging solution (prior to being contacted with the spent battery) may be in a range from about 0.01 M to about 5 M. For example, in some embodiments, the salt with high oxidation number cation may have a concentration in the range from about 0.01 M to about 0.5 M and the salt with the low oxidation number cation may have a concentration in the range from about 0.05 M to about 5 M.

Terminals 242 and 244 may be immersed in the discharging solution 230. The terminals 242 and 244 may be the external electrodes of the battery in some embodiments. In some embodiments, the terminals 242 and 244 may be conductors connected to the external electrodes of the battery to be discharged.

Additionally, a contact controller 246 is provided in the system 200. The contact controller 246 controls the contact between the external electrodes of the battery and the discharging solution. Thus, in embodiments where the terminals 242 and 244 are conductors connected to the external electrodes of the battery, the contact controller 246 may be a switch that can close or open the circuit between the external electrodes of the battery and the terminals 242/244. On the other hand, in embodiments where the terminals 242/244 are themselves external electrodes of the battery, the contact controller 246 may be an immersion controller (e.g., a robotic arm or the like), that can immerse or remove the battery from the discharging solution 230.

The system further includes a controller 250 configured to control various subsystems associated with the system 200. For example, the controller 250 may include a temperature controller 252 configured to maintaining the temperature of the discharging solution 230, a battery discharge controller 254 configured to initiate or stop the process of discharging the battery, and an agitation controller 256 configured to control the agitation level of the discharging solution.

The temperature controller 252 may be any suitable controller, e.g., a PID controller that is coupled to a temperature regulator 262 configured to maintain a temperature of the discharging solution. The temperature regulator 262 may be suitable heat exchanger such as, for example, a water jacket around the container 220. In some embodiments, the temperature controller 252 may be coupled to a water pump that pumps water through a water jacket around the container 220, and a temperature sensor (not shown) configured to sense the temperature of the discharging solution. Thus, the temperature controller 252 may increase or decrease the circulation of water around the container 220 depending on the temperature of the discharging solution as sensed by the temperature sensor.

The battery discharge controller 254 may be coupled to a voltage sensor 248 included in the discharge circuit, and may be configured to control the contact controller 246 so as to initiate or disengage a contact between the external electrodes of the battery and the discharging solution 230. For example, in embodiments where the contact controller 246 is a switch as discussed herein, the battery discharge controller 254 may turn the switch ON (thereby closing the discharge circuit) or OFF (thereby opening the discharge circuit) based on the voltage across the external electrodes of the battery as sensed by the voltage sensor 248. Thus, when the voltage across the external electrodes of the battery is reduced below a certain threshold, the battery discharge controller 254 may turn the switch OFF, thereby stopping the discharging process.

Similarly, in embodiments where the contact controller 246 is a robotic arm or the like that can immerse or remove the battery from the discharging solution 230, the battery discharge controller 254 may cause the robotic arm to remove the battery from the discharging solution 230 when the voltage across the external electrodes of the battery is reduced below a certain threshold, thereby stopping the discharging process.

As discussed elsewhere herein, a suitable threshold voltage may be determined based on the reduction potential of the redox couple in the discharging solution and risk tolerance for the processes used during subsequent recycling of the battery.

Without wishing to be bound by theory, as the voltage across the battery reduces, the rate of discharging may reduce, e.g., because of the kinetics of the various species generated during the discharging process. By agitating the discharging solution, the kinetics of the various ionic species may be suitably changed (e.g., by increasing the mobility of the ionic species) to increase and/or maintain the rate of discharging.

The agitation controller 256 may be coupled to a means 264 for agitating the discharging solution 230, such as, for example stirrer, an ultrasound generator, or a rocker. The agitation controller 256 may be further coupled to the voltage sensor 248, and may be configured to determine a rate of discharging of the battery based on the voltage sensed by the voltage sensor 248.

For example, in embodiments where the means 264 for agitating the discharging solution 230 is an ultrasound generator, the agitation controller 256 may increase or decrease the amplitude and/or frequency of the ultrasound vibrations so as to maintain, decrease and/or increase the rate of discharging of the battery when the discharging circuit is closed.

Similarly, in embodiments where the means 264 for agitating the discharging solution 230 is a stirrer, e.g., a magnetic stirrer, the agitation controller 256 may increase or decrease the rate of rotation of the stirrer based on the rate of discharge of the battery.

Likewise, in embodiments where the means 264 for agitating the discharging solution 230 is a rocker, the agitation controller 256 may change the amplitude and/or frequency of rocking of the container so as to maintain, decrease and/or increase the rate of discharging the battery when the discharging circuit is closed.

Those of skill in the art would appreciate that batteries and/or battery cells are available in many form factors and have connector tabs made from various materials depending on specific use cases. Consequently, in some embodiments, the discharging solution may include additional salts, acids or bases for specific types of batteries in order to protect the tab materials from corrosion from reaction with the cations or anions in the discharging solution. For example, in some embodiments, the discharging solution may additionally include an organic acid such as, for example, citric acid in a suitable concentration.

Thus, by suitably selecting the threshold voltage at which the stop the discharging process, and by suitably controlling the temperature and agitation of the discharging solution during the process of discharging the battery, the efficiency of the discharging process may be further increased without compromising on the safety of the discharging process or the subsequent discharging processes.

Thus, the present disclosure provides a system and method for safely and efficiently discharging spent lithium ion batteries without generating hazardous by-products. Advantageously, by suitably selecting the redox couple in the discharging solution, the by-product of the discharging process can be reused in the discharging solution without expending additional energy, thereby making the process cost-efficient.

### Examples

Experiments were performed to check the packing fraction (i.e., number of batteries used in a bath of a given size at one time), where amount of discharge liquid required to immerse a given number of cells was determined. A given number of cells were inserted into a glass container of a suitable size (e.g., a one liter capacity beaker), and the discharging solution was added to the container to a level where all the cells are completely immersed in discharging solution. When a one liter capacity beaker was used, immersing 14 cells required about 230 ml of liquid. For cylindrical batteries typically found in electric vehicles, optimum packing fraction was found to be 1:16 for cell:solution (by volume). For mobile batteries, this ratio was 1:17. The discharging solution can be agitated either by a magnetic stirrer or using an electric pump depending on the size of the container being used. During these trials, it was also observed that at bulk level, collective phenomenon accelerates the kinetics of discharge process and hence batteries with different form factors can also be discharge repeatedly.

Table 1 provides a summary of the rate of discharge kinetics for different form factor batteries using different discharging solutions, and whether the discharging solution is reusable for the given form factor.

TABLE 1

| Sr | | Discharge Kinetics | | Repetition | |
|---|---|---|---|---|---|
| No | Bath Composition | Cylindrical | Mobile | Cylindrical | Mobile |
| 1. | Solution 1 | Fast | Slow | Working | Not working |
| 2. | Solution 2 | Fast | Slow | Working | Not working |
| 3. | Solution 1 + high CA concentration | Medium | Medium | Working | Working |
| 4. | Solution 1 + Low CA concentration | Medium | Slow | Working | Not working (But working in bulk) |
| 5. | Solution 3 + high CA | Slower | Slower (for bulk) | Not working | Not working |
| 6. | Solution 4 + high CA concentration | Faster | Faster | Working | Working |
| 7. | Solution 4 | Medium | Slower | Not working | Not working |

CA: Citric Acid
Solution 1: FeSO₄:Fe₂(SO₄)₃ is about 2:1; high FeSO₄ concentration
Solution 2: FeSO₄:Fe₂(SO₄)₃ is about 2:1; low FeSO₄ concentration
Solution 3: only Fe₃(SO₄)₃ (low concentration)
Solution 4: only Fe₃(SO₄)₃ (high concentration)

### Further Considerations

In some embodiments, any of the clauses herein may depend from any one of the independent clauses or any one of the dependent clauses. In one aspect, any of the clauses (e.g., dependent or independent clauses) may be combined with any other one or more clauses (e.g., dependent or independent clauses). In one aspect, a claim may include some or all of the words (e.g., steps, operations, means or components) recited in a clause, a sentence, a phrase or a paragraph. In one aspect, a claim may include some or all of the words recited in one or more clauses, sentences, phrases or paragraphs. In one aspect, some of the words in each of the clauses, sentences, phrases or paragraphs may be removed. In one aspect, additional words or elements may be added to a clause, a sentence, a phrase or a paragraph. In one aspect, the subject technology may be implemented without utilizing some of the components, elements, functions or operations described herein. In one aspect, the subject technology may be implemented utilizing additional components, elements, functions or operations.

The subject technology is illustrated, for example, according to various aspects described below. Various examples of aspects of the subject technology are described as numbered clauses (1, 2, 3, etc.) for convenience. These are provided as examples and do not limit the subject technology. It is noted that any of the dependent clauses may be combined in any combination, and placed into a respective independent clause, e.g., clause 1 or clause 5. The other clauses can be presented in a similar manner.

Clause 1. A method of discharging a spent lithium-ion (Li-ion) battery, the method comprising: contacting external electrodes of the spent Li-ion battery to a discharging solution. The discharging solution comprises an aqueous solution of salts having a same anion and a redox couple as cations. The redox couple comprises a first cation of a metal having a first oxidation state and a second cation of the same metal having a second oxidation state different from the first oxidation state.

Clause 2. The method of clause 1, wherein the redox couple is selected from the group consisting of Fe²⁺/Fe³⁺, Cut/Cu²⁺, Mn²⁺/Mn³⁺, Sn²⁺/Sn⁴⁺, Cr³⁺/Cr⁶⁺, Co²⁺/Co³⁺, Ni²⁺/Ni³⁺, Sn²⁺/Sn⁴⁺, and Pb²⁺/Pb⁴⁺.

Clause 3. The method of any one of clauses 1-2, wherein the anion is one selected from the group consisting of sulfate, phosphate, nitrate, oxide, chloride, acetate, oxalate, carbonate and hydroxide.

Clause 4. The method of any one of clauses 1-3, wherein the solution comprises a salt with the first cation at saturation concentration and/or a salt with the second cation at saturation concentration.

Clause 5. The method of any one of clauses 1-4, wherein the solution comprises a salt with the first cation at a concentration in a range from about 0.1 M to about 0.3 M and a salt with the second cation at a concentration in a range from about 0.1 M to about 0.15 M.

Clause 6. The method of any one of clauses 1-5, wherein contacting the external electrodes to the discharging solution comprises immersing the external electrodes in a container filled with the discharging solution.

Clause 7. The method of any one of clauses 1-6, wherein contacting the external electrodes to the discharging solution comprises contacting the external electrodes to a first end of an electrical conductor, and contacting a second end of the electrical conductor to the discharging solution.

Clause 8. The method of any one of clauses 1-7, further comprises maintaining a temperature of the discharging solution while the external electrodes are contacted with the discharging solution.

Clause 9. The method of any one of clauses 1-8, further comprises applying ultrasound vibrations to the discharging solution while the external electrodes are contacted with the discharging solution.

Clause 10. The method of any one of clauses 1-9, further comprises measuring an electrical potential across the external electrodes while external electrodes are contacted with the discharging solution.

Clause 11. The method of any one of clauses 1-10, further comprises maintaining a contact between the external electrodes and the discharging solution until the electrical potential across the external electrodes is reduced below a threshold voltage.

Clause 12. The method of clause 11, wherein the threshold voltage is in a range from about 50 mV to about 1.5 V.

Clause 13. The method of any one of clauses 1-12, wherein the discharging solution comprises ferrous sulfate and ferric sulfate; ferrous nitrate and ferric nitrate; ferrous chloride and ferric chloride; ferrous acetate and ferric acetate; or ferrous oxalate and ferric oxalate.

Clause 14. A system for discharging a spent Li-ion battery, the system comprising: a container comprising a discharging solution comprising an aqueous solution of salts having a same anion and a redox couple as cations; a voltage sensor configured to measure a voltage across external electrodes of the spent Li-ion battery; and a controller operably connected to the voltage sensor. The controller is configured to: initiate a contact between external electrodes of the spent Li-ion battery and the discharging solution, and disengage the contact between the external electrodes and the discharging solution when the voltage measured by the voltage sensor across the external electrodes of the spent Li-ion battery being below a threshold voltage. The redox couple comprises a first cation of a metal having a first oxidation state and a second cation of the same metal having a second oxidation state different from the first oxidation state.

Clause 15. The system of clause 14, wherein the anion is one selected from the group consisting of sulfate, phosphate, nitrate, oxide, chloride, acetate, oxalate, carbonate and hydroxide.

Clause 16. The system of any one of clauses 14-15, wherein the redox couple is selected from the group consisting of Fe²⁺/Fe³⁺, Cut/Cu²⁺, Mn²⁺/Mn³⁺, Sn²⁺/Sn⁴⁺, Cr³⁺/Cr⁶⁺, Co²⁺/Co³⁺, Ni²⁺/Ni³⁺, Sn²⁺/Sn⁴⁺, and Pb²⁺/Pb⁴⁺.

Clause 17. The system of any one of clauses 14-16, wherein the discharging solution comprises an aqueous solution of ferrous sulfate and ferric sulfate.

Clause 18. The system of any one of clauses 14-17, wherein the threshold voltage is in a range from about 0.1 V to about 1.5 V.

Clause 19. The system of any one of clauses 14-18, wherein initiating contact between external electrodes of the spent Li-ion battery and the discharging solution comprises immersing the spent Li-ion battery into the container such that external electrodes of the spent Li-ion battery contact the discharging solution, and disengaging the contact between the external electrodes of the spent Li-ion battery comprises removing the spent Li-ion battery from the container such that the external electrodes do not contact the discharging solution.

Clause 20. The system of any one of clauses 14-19, further comprising an ultrasound generator configured to generate ultrasound vibrations and apply the ultrasound vibrations to the discharging solution, wherein the controller is further configured to control the ultrasound generator.

Clause 21. The system of any one of clauses 14-20, further comprising a temperature regulator operably coupled to the container and configured to maintain the temperature of the discharging solution while the external electrodes are contacted with the discharging solution.

Clause 22. A discharging solution comprising an aqueous solution of salts having a same anion and a redox couple as cations. The redox couple comprises a first cation of a metal having a first oxidation state and a second cation of the same metal having a second oxidation state different from the first oxidation state. The discharging solution is configured to reduce an electric potential across a battery, when an electrical contact is made between the discharging solution and external terminals of the battery, without evolution of gaseous byproducts.

Clause 23. The discharging solution according to clause 22, wherein the redox couple is selected from the group consisting of Fe²⁺/Fe³⁺, Cut/Cu²⁺, Mn²⁺/Mn³⁺, Sn²⁺/Sn⁴⁺, Cr³⁺/Cr⁶⁺, Co²⁺/Co³⁺, Ni²⁺/Ni³⁺, Sn²⁺/Sn⁴⁺, and Pb²⁺/Pb⁴⁺.

Clause 24. The discharging solution according to any one of clauses 22-23, wherein the anion is one selected from the group consisting of sulfate, phosphate, nitrate, oxide, chloride, acetate, oxalate, carbonate and hydroxide.

Clause 25. The discharging solution according to any one of clauses 22-24, wherein the discharging solution comprises a salt with the first cation at saturation concentration and/or a salt with the second cation at saturation concentration.

Clause 26. The discharging solution according to any one of clauses 22-25, wherein the discharging solution comprises a salt with the first cation at a concentration in a range from about 0.1 M to about 0.3 M and a salt with the second cation at a concentration in a range from about 0.1 M to about 0.15 M.

Clause 27. The discharging solution according to any one of clauses 22-26, wherein the discharging solution comprises ferrous sulfate and ferric sulfate; ferrous nitrate and ferric nitrate; ferrous chloride and ferric chloride; ferrous acetate and ferric acetate; or ferrous oxalate and ferric oxalate.

Clause 28. The discharging solution according to any one of clauses 22-27, further comprising an organic acid.

The foregoing description is provided to enable a person skilled in the art to practice the various configurations described herein. While the subject technology has been particularly described with reference to the various figures and configurations, it should be understood that these are for illustration purposes only and should not be taken as limiting the scope of the subject technology.

There may be many other ways to implement the subject technology. Various functions and elements described herein may be partitioned differently from those shown without departing from the scope of the subject technology. Various modifications to these configurations will be readily apparent to those skilled in the art, and generic principles defined herein may be applied to other configurations. Thus, many changes and modifications may be made to the subject technology, by one having ordinary skill in the art, without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

As used herein, the term “about” preceding a quantity indicates a variance from the quantity. The variance may be caused by manufacturing tolerances or may be based on differences in measurement techniques. The variance may be up to 10% from the listed value in some instances. Those of ordinary skill in the art would appreciate that the variance in a particular quantity may be context dependent and thus, for example, the variance in a dimension at a micro or a nano scale may be different than variance at a meter scale.

As used herein, the phrase “at least one of” preceding a series of items, with the term “and” or “or” to separate any of the items, modifies the list as a whole, rather than each member of the list (i.e., each item). The phrase “at least one of” does not require selection of at least one of each item listed; rather, the phrase allows a meaning that includes at least one of any one of the items, and/or at least one of any combination of the items, and/or at least one of each of the items. By way of example, the phrases “at least one of A, B, and C” or “at least one of A, B, or C” each refer to only A, only B, or only C; any combination of A, B, and C; and/or at least one of each of A, B, and C.

Terms such as “top,” “bottom,” “front,” “rear” and the like as used in this disclosure should be understood as referring to an arbitrary frame of reference, rather than to the ordinary gravitational frame of reference. Thus, a top surface, a bottom surface, a front surface, and a rear surface may extend upwardly, downwardly, diagonally, or horizontally in a gravitational frame of reference.

Furthermore, to the extent that the term “include,” “have,” or the like is used in the description or the claims, such term is intended to be inclusive in a manner similar to the term “comprise” as “comprise” is interpreted when employed as a transitional word in a claim.

The word “exemplary” is used herein to mean “serving as an example, instance, or illustration.” Any embodiment described herein as “exemplary” is not necessarily to be construed as preferred or advantageous over other embodiments.

A reference to an element in the singular is not intended to mean “one and only one” unless specifically stated, but rather “one or more.” Pronouns in the masculine (e.g., his) include the feminine and neuter gender (e.g., her and its) and vice versa. The term “some” refers to one or more. Underlined and/or italicized headings and subheadings are used for convenience only, do not limit the subject technology, and are not referred to in connection with the interpretation of the description of the subject technology. All structural and functional equivalents to the elements of the various configurations described throughout this disclosure that are known or later come to be known to those of ordinary skill in the art are expressly incorporated herein by reference and intended to be encompassed by the subject technology. Moreover, nothing disclosed herein is intended to be dedicated to the public regardless of whether such disclosure is explicitly recited in the above description.

What is claimed is:

1. A method of discharging a spent lithium-ion (Li-ion) battery, the method comprising:
contacting external electrodes of the spent Li-ion battery to a discharging solution,
wherein the discharging solution comprises an aqueous solution of salts having a same anion and a redox couple as cations,
wherein the redox couple comprises a first cation of a metal having a first oxidation state and a second cation of the same metal having a second oxidation state different from the first oxidation state.

2. The method of claim 1, wherein the redox couple is selected from the group consisting of Fe²⁺/Fe³⁺, Cut/Cu²⁺, Mn²⁺/Mn³⁺, Sn²⁺/Sn⁴⁺, Cr³⁺/Cr⁶⁺, Co²⁺/Co³⁺, Ni²⁺/Ni³⁺, Sn²⁺/Sn⁴⁺, and Pb²⁺/Pb⁴⁺.

3. The method of claim 1, wherein the anion is one selected from the group consisting of sulfate, phosphate, nitrate, oxide, chloride, acetate, oxalate, carbonate and hydroxide.

4. The method of claim 1, wherein the solution comprises a salt with the first cation at saturation concentration and/or a salt with the second cation at saturation concentration.

5. The method of claim 1, wherein the solution comprises a salt with the first cation at a concentration in a range from about 0.1 M to about 0.3 M and a salt with the second cation at a concentration in a range from about 0.1 M to about 0.15 M.

6. The method of claim 1, wherein contacting the external electrodes to the discharging solution comprises immersing the external electrodes in a container filled with the discharging solution.

7. The method of claim 1, wherein contacting the external electrodes to the discharging solution comprises contacting the external electrodes to a first end of an electrical conductor, and contacting a second end of the electrical conductor to the discharging solution.

8. The method of claim 1, further comprises maintaining a temperature of the discharging solution while the external electrodes are contacted with the discharging solution.

9. The method of claim 1, further comprises applying ultrasound vibrations to the discharging solution while the external electrodes are contacted with the discharging solution.

10. The method of claim 1, further comprises measuring an electrical potential across the external electrodes while external electrodes are contacted with the discharging solution.

11. The method of claim 10, further comprises maintaining a contact between the external electrodes and the discharging solution until the electrical potential across the external electrodes is reduced below a threshold voltage.

12. The method of claim 11, wherein the threshold voltage is in a range from about 50 mV to about 1.5 V.

13. The method of claim 1, wherein the discharging solution comprises ferrous sulfate and ferric sulfate; ferrous nitrate and ferric nitrate; ferrous chloride and ferric chloride; ferrous acetate and ferric acetate; or ferrous oxalate and ferric oxalate.

14. A system for discharging a spent Li-ion battery, the system comprising:
a container comprising a discharging solution comprising an aqueous solution of salts having a same anion and a redox couple as cations;
a voltage sensor configured to measure a voltage across external electrodes of the spent Li-ion battery; and
a controller operably connected to the voltage sensor, and configured to:
initiate a contact between external electrodes of the spent Li-ion battery and the discharging solution, and
disengage the contact between the external electrodes and the discharging solution when the voltage measured by the voltage sensor across the external electrodes of the spent Li-ion battery being below a threshold voltage,
wherein the redox couple comprises a first cation of a metal having a first oxidation state and a second cation of the same metal having a second oxidation state different from the first oxidation state.

15. The system of claim 14, wherein the anion is one selected from the group consisting of sulfate, phosphate, nitrate, oxide, chloride, acetate, oxalate, carbonate and hydroxide.

16. The system of claim 14, wherein the redox couple is selected from the group consisting of Fe²⁺/Fe³⁺, Cut/Cu²⁺, Mn²⁺/Mn³⁺, Sn²⁺/Sn⁴⁺, Cr³⁺/Cr⁶⁺, Co²⁺/Co³⁺, Ni²⁺/Ni³⁺, Sn²⁺/Sn⁴⁺, and Pb²⁺/Pb⁴⁺.

17. The system of claim 14, wherein the discharging solution comprises an aqueous solution of ferrous sulfate and ferric sulfate.

18. The system of claim 14, wherein the threshold voltage is in a range from about 0.1 V to about 1.5 V.

19. The system of claim 14, wherein initiating contact between external electrodes of the spent Li-ion battery and the discharging solution comprises immersing the spent Li-ion battery into the container such that external electrodes of the spent Li-ion battery contact the discharging solution, and disengaging the contact between the external electrodes of the spent Li-ion battery comprises removing the spent Li-ion battery from the container such that the external electrodes do not contact the discharging solution.

20. The system of claim 14, further comprising an ultrasound generator configured to generate ultrasound vibrations and apply the ultrasound vibrations to the discharging solution, wherein the controller is further configured to control the ultrasound generator.

21. The system of claim 14, further comprising a temperature regulator operably coupled to the container and configured to maintain the temperature of the discharging solution while the external electrodes are contacted with the discharging solution.
